(19) United States
(12) Patent Application Publication
(10) Pub. No.: US 2010/0026870 A1
(43) Pub. Date: Feb. 4, 2010

(54) Image pickup device having display function and mobile communication terminal

(75) Inventor: Akito Sakemoto, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-Shi (JP)

(21) Appl. No.: 12/458,939

(22) Filed: Jul. 28, 2009

(30) Foreign Application Priority Data
Jul. 29, 2008 (JP) 2008-195098

(51) Int. Cl. H04N 5/222

(52) U.S. Cl. 348/333.01; 348/E05.022

(57) ABSTRACT

In an image pickup device, an image receiving surface is divided into a plurality of unit areas. The image pickup device establishes a predefined unit area as a light transmission area based on electrical control, receives externally-incoming light through this established unit area, and takes an externally-incoming image based on the externally-incoming light. Further, the image pickup device establishes a predefined unit area as a light transmission area based on electrical control, and displays an image by externally outputting light through this established unit area.

### BACKGROUND OF THE INVENTION

1. Field of the Invention

The present invention relates to an image pickup device having a display function and a mobile communication terminal.

2. Description of Related Art

In recent years, the progress of technological developments relating to biometric authentication, which is a sort of image pickup device, has been remarkable. Note that the biometric authentication is a technology for identifying a certain individual from other individuals based on a decision whether or not biological information obtained from an individual to be tested is identical to pre-established biological information. Examples of the biometric authentication include a method for identifying an individual based on the iris of a human pupil, a method for identifying an individual based on the vein pattern of a human finger or the like, and a method for identifying an individual based on the fingerprint pattern of a finger. Above all, the one using the vein pattern of a human finger or the like can ensure higher security because disguising pattern data is very difficult.

Japanese Unexamined Patent Application Publication No. 2001-119008 discloses an image pickup device used for biometric authentication. In this image pickup device, a light source, a support pedestal, and an image authentication unit are stacked in an attempt to miniaturize the image pickup device.

The image pickup device disclosed in Japanese Unexamined Patent Application Publication No. 2001-119008 is equipped with the image pickup function alone. That is, the image pickup device disclosed in Japanese Unexamined Patent Application Publication No. 2001-119008 is not configured to include any display function in addition to the image pickup function.

### SUMMARY OF THE INVENTION

In an exemplary aspect, the present invention has been made to solve such a problem, and an object of the present invention is to provide an image pickup device that is capable of obtaining a desired image and also equipped with a display function, and a mobile communication device.

In accordance with an exemplary aspect of the present invention, an image pickup device having a display function, in which an image receiving surface is divided into a plurality of unit areas, configured to: establish a predefined unit area as a light transmission area based on electrical control, receive externally-incoming light through this established unit area, and take an externally-incoming image based on that externally-incoming light; and establish a predefined unit area as a light transmission area based on electrical control, and display an image by externally outputting light through this established unit area. In this way, the image pickup device can obtain a desired image, and is also configured to include a display function.

The image pickup device preferably includes a filter layer in which the image receiving surface is divided into the plurality of unit areas and a predefined unit area is established as a light transmission area based on electrical control; an image pickup element including at least one pixel row; first light guide means that guides externally-incoming light from the filter layer to the pixel row; and a visible-light source that generates light to be externally output through the filter layer. In this way, externally-incoming light that passed through the unit area established as the light transmission area enters each pixel of the image pickup element through the first light guide means. The image pickup device successively shifts the unit area established as the light transmission area, and thereby successively detects an externally-incoming image in each unit area with the image pickup element. Consequently, the image pickup device can take the whole externally-incoming image received on the surface area of the filter layer. Therefore, the image pickup device can obtain a desired image by using an image pickup element having a small number of pixels.

The first light guide means is preferably an optical member that guides received externally-incoming light to pixels of the image pickup element through a plurality of reflection planes.

The optical member is preferably composed of a plurality of guide members arranged adjacent to one another.

Each of the plurality of the guide members preferably includes a plurality of first reflection planes that direct received externally-incoming light toward one end of that guide member, and a second reflection plane provided on the one end side of that guide member, the second reflection plane being configured to reflect externally-incoming light that propagated through that guide member toward pixels of the image pickup element.

The image pickup device preferably includes second light guide means disposed so as to connect the second reflection planes of the plurality of guide members with one another. The visible-light source is preferably disposed in an end portion of the second light guide means. Further, the first reflection planes of the guide members preferably reflect light received from the visible-light source toward the filter layer while making the received light propagate toward the other end of the guide members. In this way, the image pickup device can reduce the number of visible-light sources.

The filter layer is preferably a dot-matrix type liquid crystal panel, and includes a liquid crystal layer, electrode layers that sandwich the liquid crystal layer and is capable of applying a voltage to each pixel of the liquid crystal layer, and a liquid crystal drive circuit that controls the electrode layers such that a predefined unit area in the liquid crystal layer becomes a light transmission area. In this way, the image pickup device can establish the unit area as a light transparent area or a light non-transparent area by using existing liquid crystal technology.

It is preferable to make each of a plurality of unit areas, which are defined by dividing the image receiving surface of the filter layer by a plurality of first axes, a light transmission area or a light non-transmission area, and thereby to create a state where externally-incoming light enters the light transmission area.

The plurality of pixels of the image pickup device are preferably arranged along the first axes, and each of the plurality of guide members preferably extends along second axes perpendicular to the first axes.

The plurality of guide members are preferably disposed above the image pickup element, and the filter layer is preferably disposed above the plurality of guide members.

Preferably, a metal reflection film is formed on the first reflection planes of the guide members. In this way, light that entered the guide members does not leak from the bottom surface of the guide members. Therefore, the light utilization efficiency becomes higher.

The visible-light source is preferably disposed in an end portion of the visible-light guide means disposed below the plurality of the guide members, and the visible-light guide means preferably outputs received light to the filter layer through the plurality of guide members.

The image pickup device preferably includes a visible-light cut filter that blocks visible-light to the image pickup element. By covering the image pickup element with the visible-light cut filter, it is possible to prevent an electrical charge from being accidentally accumulated in pixels of the image pickup element by unnecessary externally-incoming light.

Preferably, an object to be tested that is placed on the image receiving surface of the filter layer is irradiated with externally-incoming light, which is near-infrared light, and a vein image is taken as an externally-incoming image.

A mobile communication terminal in accordance with an exemplary aspect of the present invention includes the above-described image pickup device. In this way, the mobile communication terminal can obtain a desired image, and is also configured to include a display function.

The present invention can provide an image pickup device that is capable of obtaining a desired image and also equipped with a display function, and a mobile communication terminal.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic view illustrating a structure of a mobile phone in accordance with a first exemplary embodiment of the present invention;

FIG. 2 is a schematic view illustrating a structure of the front of a mobile phone in accordance with a first exemplary embodiment of the present invention;

FIG. 3 is an enlarged schematic view illustrating a structure of the front of a mobile phone in accordance with a first exemplary embodiment of the present invention;

FIG. 4 is a schematic exploded perspective view of a structure of an image pickup device in accordance with a first exemplary embodiment of the present invention;

FIG. 5 is a schematic plane view illustrating a positional relation between pixels of a line sensor, a guide member of first guide means, and unit electrodes;

FIG. 6 is a schematic view illustrating a schematic side structure of an image pickup device in accordance with a first exemplary embodiment of the present invention;

FIG. 7 is a schematic plane view illustrating a positional relation between unit electrodes and unit areas of a liquid crystal layer;

FIG. 8 is a schematic block diagram of a drive system of a liquid crystal panel;

FIG. 9 is a flowchart for explaining operations for biometric authentication in accordance with a first exemplary embodiment of the present invention;

FIG. 10 is a schematic view showing propagation of test light as an image is taken by using an image pickup device in accordance with a first exemplary embodiment of the present invention;

FIG. 11 shows control signals of a light source and a liquid crystal panel as an image is taken;

FIG. 12 shows control signals of a visible-light source and a liquid crystal panel as an image is displayed;

FIG. 13 is a schematic view showing propagation of visible light as an image is displayed by using an image pickup device in accordance with a first exemplary embodiment of the present invention;

FIG. 14 is a schematic view illustrating a schematic side structure of an image pickup device in accordance with a second exemplary embodiment of the present invention; and

FIG. 15 is a schematic view illustrating a schematic side structure of an image pickup device in accordance with a third exemplary embodiment of the present invention.

### DESCRIPTION OF THE PREFERRED EMBODIMENTS

Exemplary embodiments of the present invention are explained hereinafter with reference to the drawings. Note that each exemplary embodiment is simplified for the sake of explanation. It should be noted that the technical scope of the present invention should not be narrowly interpreted because of the fact that the drawings are simplified. The drawings are made only for illustrating the technical features, and they do not reflect the exact sizes and the likes of components shown in the drawings. The same signs are assigned to the same components, and the duplication of explanation will be omitted. Note that terms indicating directions such as “up”, “down”, “left”, and “right” are used to represent the directions as the drawings are viewed from the front unless otherwise noted.

### First Exemplary Embodiment

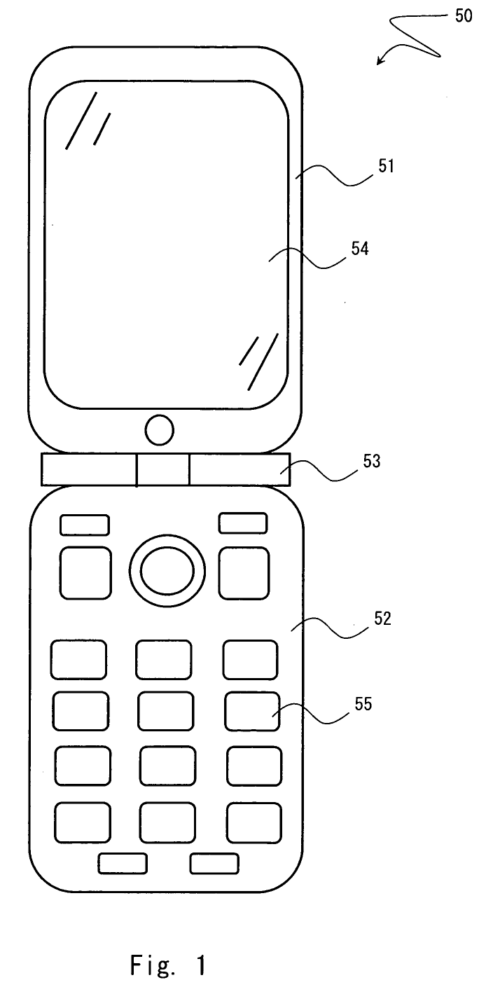

An image pickup device equipped with a display function and a mobile communication terminal in accordance with a first exemplary embodiment of the present invention are explained with reference to FIGS. 1 to 13.

As shown in FIG. 1, a mobile communication terminal in accordance with this exemplary embodiment is a mobile phone 50. The mobile phone 50 includes an upper-side body (first member) 51, a lower-side body (second member) 52, and a hinge 53. Each of the upper-side body 51 and the lower-side body 52 is a flat-plate member made of plastic. The upper-side body 51 and the lower-side body 52 are connected by means of the hinge 53. The upper-side body 51 and the lower-side body 52 are constructed so as to freely open and close by the hinge 53. When the upper-side body 51 and the lower-side body 52 are in a closed state, the mobile phone 50 becomes a plate-shaped member in which the upper-side body 51 and the lower-side body 52 are placed on top of the other.

The upper-side body 51 includes a display unit 54 on its inner surface. The display unit 54 displays information specifying a caller (name and phone number) and an address book and the like stored in the storage unit of the mobile phone 50. A liquid crystal display device is embedded below the display unit 54.

The lower-side body 52 includes a plurality of buttons 55 on its inner surface. A user of the mobile phone 50 operates the mobile phone 50 as he/she wants, such as opening an address book, making a phone call, and setting the phone to a silent mode, by manipulating the buttons 55.

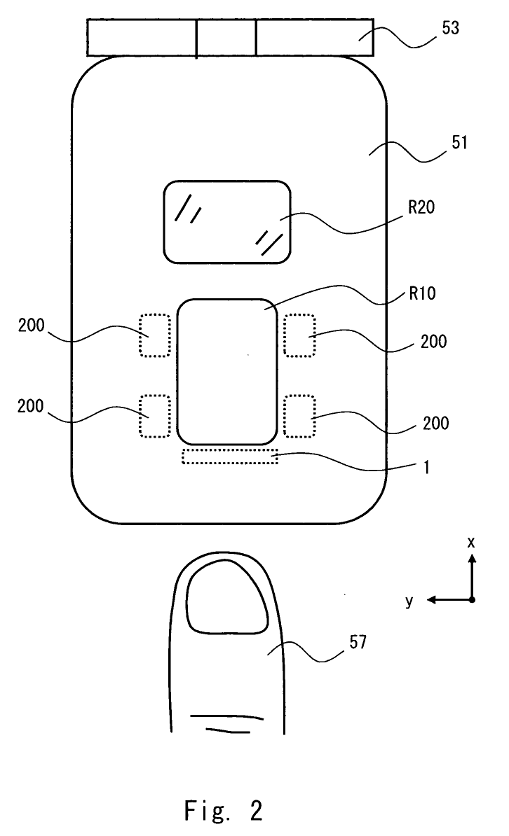

As shown in FIG. 2, a substantially transparent surface area R10 and a surface area R20 are arranged on the outer surface of the upper-side body 51.

A finger 57 of a human (subject) is put on the surface area R10. An image pickup device 100 is embedded below the surface area R10. Note that an image pickup device 100 and a light source(s) 200 constitute a biometric authentication device in this exemplary embodiment of the present invention.

Text (time, operating state, and name of caller and the like) is displayed in the surface area R20. A liquid crystal display device is embedded below the surface area R20. This liquid crystal display device is a typical liquid crystal display device including upper electrodes, a liquid crystal layer, and lower electrodes.

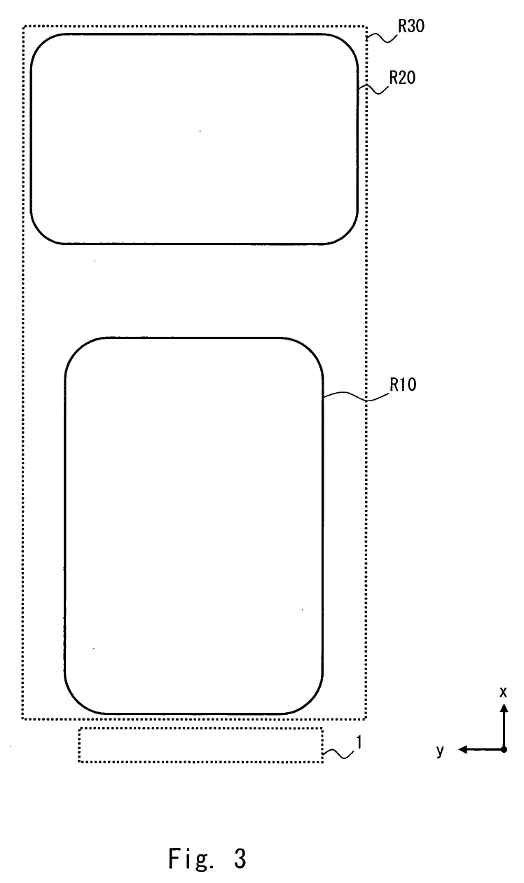

As shown in FIG. 3, the surface area R10 and the surface area R20 are located in the area R30 in which the liquid crystal layer is also located. In this exemplary embodiment of the present invention, both the liquid crystal layer contained in the image pickup device 100 located below the surface area R10 and the liquid crystal layer contained in the liquid crystal display device located below the surface area R20 are located in the same layer and formed in the one and same manufacturing process.

The image pickup device 100 located below the surface area R10 and the liquid crystal display device located below the surface area R20 share common components. In this way, it is possible for the mobile phone 50 to reduce the costs required to incorporate the image pickup device 100 into the mobile phone 50. Note that the shared components may include polarizing plates sandwiching the liquid crystal layer, transparent substrates sandwiching the liquid crystal layer, and lower electrodes or upper electrodes, as well as the liquid crystal layer. In any case, the shared components are located in mutually the same layers.

In the image pickup device 100, the image receiving surface is divided into a plurality of unit areas, and a predefined unit area is established as a light transmission area based on electrical control. Further, the image pickup device 100 receives externally-incoming light through the unit area established as the light emission area, and is constructed so that it can take an externally-incoming image based on that externally-incoming light.

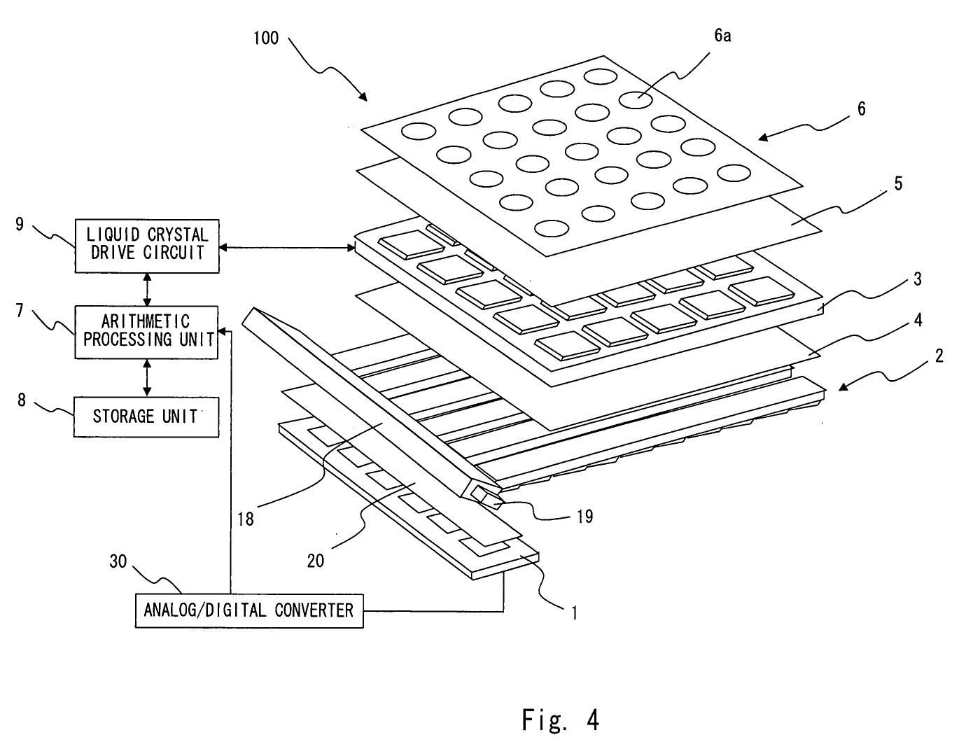

Specifically, as shown in FIG. 4, the image pickup device 100 includes a line sensor (image pickup element) 1, first light guide means 2, a filter layer 3, polarizing plates 4 and 5, and a micro-lens array 6. Further, the image pickup device 100 also includes an arithmetic processing unit 7, a storage unit 8, and a liquid crystal drive circuit 9 and the like.

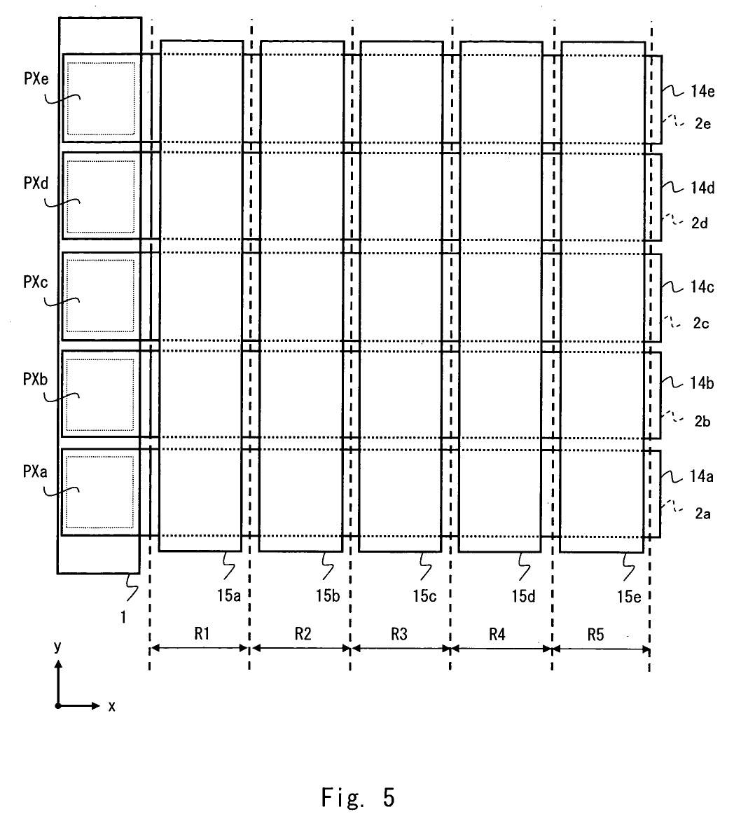

The line sensor 1 is an image pickup element in which a plurality of pixels are arranged in one row. The line sensor 1 has roughly the same width as the width of the liquid crystal panel 3. The line sensor 1 is a PD (Photodiode) array sensor in which photodiodes are arranged in a row, a MOS (Metal Oxide Semiconductor) array sensor in which MOS type pixels are arranged in a row, or a similar sensor. As shown in FIG. 2, this line sensor 1 is disposed in one of the side portions of the surface area R10 (bottom side of the surface area R10 in FIG. 2) of the mobile phone 50. That is, as shown in FIG. 5, pixels PXa to PXe are lined up in the y-axis direction in the line sensor 1. However, the only requirement is that it should have at least one row of pixels.

The first light guide means 2 has a planar area having roughly the same size as the planar area of the liquid crystal panel 3. As shown in FIGS. 4 and 5, the first light guide means 2 in accordance with this exemplary embodiment of the present invention is an optical member composed of a plurality of guide members 2a to 2e that are arranged so as to correspond to the respective pixels PXa to PXe of the line sensor 1. Each of the guide members 2a to 2e is an optical member substantially transparent to light. The guide members 2a to 2e extend in the x-axis direction and are arranged in such a manner that they are adjacent to and parallel with one another.

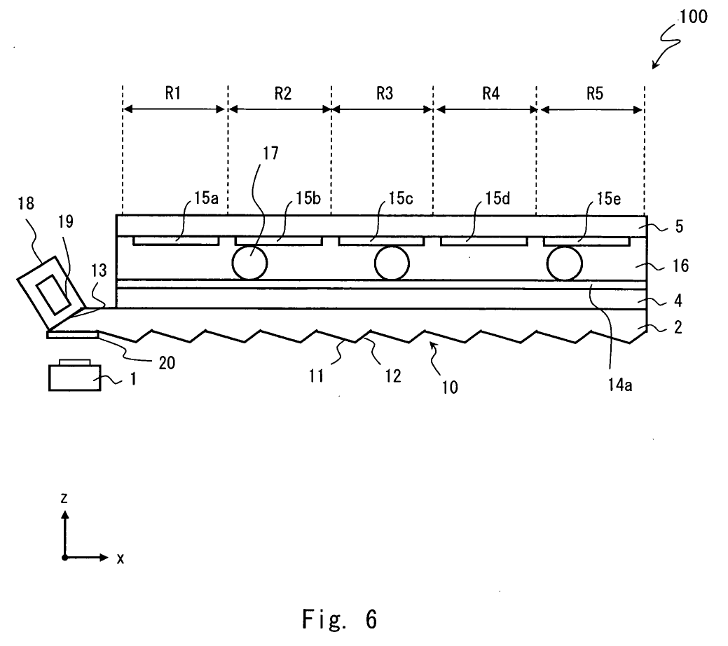

As shown in FIG. 6, the guide members 2a to 2e have a flat top surface, and have a plurality of grooves 10 formed on their bottom surface. The grooves 10 extend in the frontward or backward direction in the figure (y-axis direction). By forming a plurality of grooves 10 on the bottom surface of the guide members 2a to 3e, a plurality of reflection planes (first reflection planes) 11 and 12 are formed on the bottom surface of the guide members 2a to 2e. Further, reflection planes (second reflection planes) 13 are formed in the left-end portions of the guide members 2a to 2e. The reflection planes 13 of the respective guide members 2a to 2e are disposed above the pixels PXa to PXe of the line sensor 1.

The filter layer 3 is composed of a dot-matrix type liquid crystal panel (hereinafter, the same sign “3” as the filter layer is assigned). The liquid crystal panel 3 is disposed above the guide members 2a to 2e. The liquid crystal panel 3 has roughly the same planar area as the surface area R10 of the mobile phone 50. As for the drive system of the liquid crystal panel 3, either the passive-matrix mode or the active-matrix mode may be used. Note that the liquid crystal panel 3 in accordance with this exemplary embodiment of the present invention is using the passive-matrix mode.

As shown in FIG. 6, the liquid crystal panel 3 includes an electrode layer (lower electrodes) 14, an electrode layer (upper electrodes) 15, and a liquid crystal layer 16. The electrode layer 14 is composed of a conductive thin film (ITO: Indium Tin Oxide). The electrode layer 14 is substantially transparent to light in a wavelength band from visible light to near-infrared light. The electrode layer 14 is composed of a plurality of unit electrodes 14a to 14e. Each of the unit electrodes 14a to 14e is an elongated signal electrode extending in the x-axis direction. The unit electrodes 14a to 14e are arranged in parallel at regular intervals. The unit electrodes 14a to 14e are formed on the upper surface of a lower transparent substrate (not shown).

The electrode layer 15 is also composed of a conductive thin-film (ITO: Indium Tin Oxide). The electrode layer 15 is substantially transparent to light in a wavelength band from visible light to near-infrared light. The electrode layer 15 is composed of a plurality of unit electrodes 15a to 15e. Each of the unit electrodes 15a to 15e is an elongated scanning electrode extending in the y-axis direction. The unit electrodes 15a to 15e are arranged in parallel at regular intervals. The unit electrodes 15a to 15e are formed on the lower surface of an upper transparent substrate (not shown) The space between the lower transparent substrate (not shown) and the upper transparent substrate (not shown) is filled with the liquid crystal layer 16. The liquid crystal layer 16 has an airtight structure. Spacer members 17 are disposed at regular intervals in the space between the lower transparent substrate and the upper transparent substrate. In this way, the liquid crystal panel 3 has a structure capable of withstanding pressure exerted on the transparent substrate.

In the liquid crystal panel 3 like this, when a voltage is applied between the pair of electrode layers composed of the electrode layers 14 and 15, a voltage is applied to the liquid crystal layer 16. The alignment state of the liquid crystal layer 16 is controlled by the application of the voltage. Specifically, each of the unit electrodes 14a to 14e and 15a to 15e is connected to the liquid crystal drive circuit 9. The liquid crystal drive circuit 9 is connected to the arithmetic processing unit 7. That is, the liquid crystal panel 3 has such a structure that the liquid crystal drive circuit 9 can control a predefined area (pixels) of the liquid crystal panel 3 based on an image pickup control signal from the arithmetic processing unit 7. In this exemplary embodiment of the present invention, intersections between unit electrodes extending in the x-axis direction and unit electrodes extending in the y-axis direction serve as pixels.

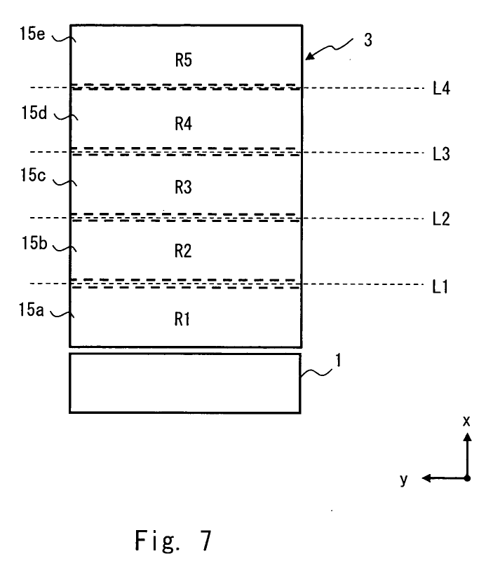

The liquid crystal drive circuit 9 in this exemplary embodiment of the present invention controls the unit electrodes 14a to 14e and 15a to 15e based on an image pickup control signal from the arithmetic processing unit 7. At this point, in the surface area (image receiving surface) of the liquid crystal panel 3, each of a plurality of unit areas, which are defined by dividing the surface area by a plurality of first axes, becomes a light transmission area. Specifically, as shown in FIG. 7, the surface area of the liquid crystal panel 3 is divided into five sections by axes (first axes) L1 to L4, and thereby unit areas R1 to R5 are defined. Note that unit areas are areas defined by dividing the surface area by a plurality of axes. The unit area R1 is formed below an axis L1, the unit area R2 is formed between the axis L1 and an axis L2, the unit area R3 is formed between the axis L2 and an axis L3, the unit area R4 is formed between the axis L3 and an axis L4, and the unit area R5 is formed above the axis L4. That is, when an externally-incoming image is taken, a group of pixels arranged in the y-axis direction of the liquid crystal panel 3 are defined as one unit area.

At this point, the unit electrodes 15a to 15e constituting the electrode layer 15 are arranged so as to correspond to the respective unit areas R1 to R5. That is, the unit electrode 15a is arranged so as to correspond to the unit area R1. The unit electrode 15b is arranged so as to correspond to the unit area R2. The unit electrode 15c is arranged so as to correspond to the unit area R3. The unit electrode 15d is arranged so as to correspond to the unit area R4. The unit electrode 15e is arranged so as to correspond to the unit area R5.

The polarizing plates 4 and 5 are arranged so as to sandwich the liquid crystal panel 3. That is, the polarizing plate 4 is disposed below the electrode layer 14 located below the liquid crystal panel 3. The polarizing plate 5 is disposed above the electrode layer 15 located above the liquid crystal panel 3. Each of the polarizing plates 4 and 5 is an optical member that lets light having a specific polarization component pass therethrough. Each of the polarizing plates 4 and 5 has roughly the same planar area as the planar area of the liquid crystal panel 3.

The micro-lens array 6 is a sheet element in which a plurality of lenses 6a are arranged in matrix. The micro-lens array 6 is disposed above the polarizing plate 5. The lenses 6a are arranged so as to correspond to the respective pixels of the liquid crystal panel 3. Therefore, it becomes possible to obtain an externally-incoming image in a wider area. Further, crosstalk of light between areas defined by the guide members 2a to 2e in a unit area can be further suppressed. Furthermore, by adjusting the focal point of the lenses 6a properly, it is possible to reduce the propagation loss of light, especially, in the first light guide means 2, and thereby increasing the light utilization efficiency of the image pickup device 100. However, note that the micro-lens array 6 is omitted in FIG. 6.

The arithmetic processing unit 7 is a CPU. The arithmetic processing unit 7 calls up an image pickup control signal stored in the storage unit 8 and outputs it to the liquid crystal drive circuit 9 according to manipulations on the mobile phone 50. Further, the arithmetic processing unit 7 controls the line sensor 1 and the light sources 200 based on the called-up image pickup control signal. Furthermore, the arithmetic processing unit 7 carries out binarization processing on an image signal from each of the pixels PXa to PXe, corrects an obtained vein pattern, and performs authentication by comparing an obtained vein pattern with a vein pattern stored on the storage unit 8. That is, the image pickup control signal is a signal that governs the output timing of image signals from the line sensor 1, the light-emission timing of the light sources 200, and the selection and the voltage application timing of the unit electrodes and the like.

The storage unit 8 is a semiconductor memory. Pre-established image pickup control signals and image signals from each pixel of the line sensor 1 are stored in the storage unit 8.

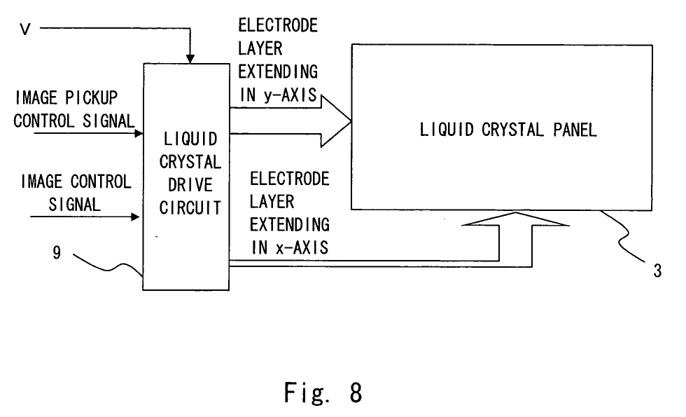

The liquid crystal drive circuit 9 is the so-called liquid crystal driver. As shown in FIG. 8, the liquid crystal drive circuit 9 controls the unit electrodes 14a to 14e and 15a to 15e of the liquid crystal panel 3 and establishes a predefined unit area as a light transmission area based on an input image pickup control signal.

a plurality of light sources 200 are disposed in opposing two of the side portions of the surface area R10 (left and right in FIG. 2). The light sources 200 emit test light in the forward direction. The test light has a wavelength band of 580 nm to 1000 nm, and preferably of 600 nm to 860 nm, which are suitable for biometric authentication. Each of the light sources 200 is, for example, a semiconductor LED (Light Emitting Diode) or a semiconductor LD (Laser Diode). The light sources 200 are controlled by a control circuit (not shown).

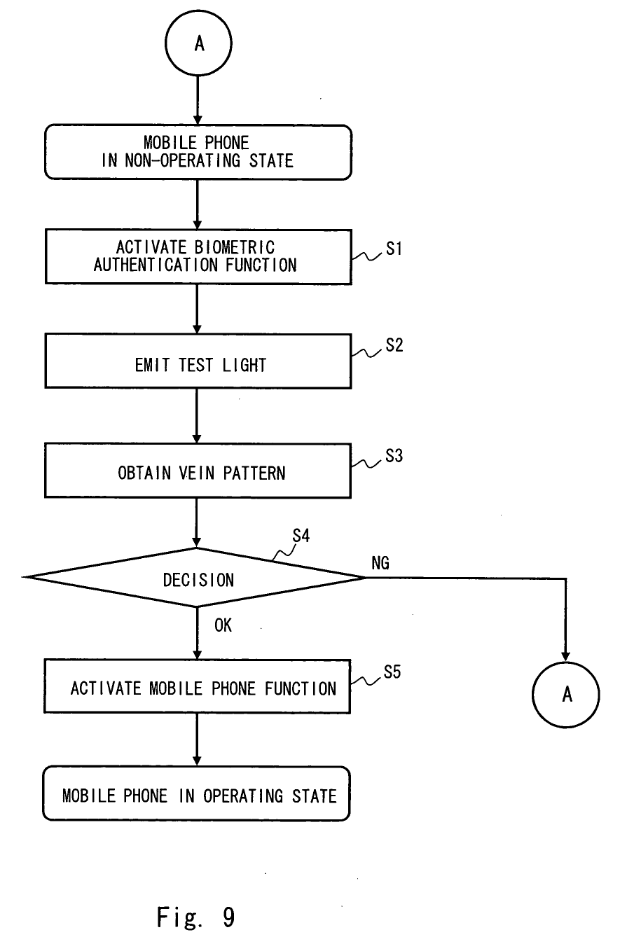

By using a biometric authentication device having the above-described structure, biometric authentication is performed in the following manner. Firstly, when a finger 57 is put on the surface area R10 of the mobile phone 50 in a non-operating state, and the mobile phone 50 activates its biometric authentication function as shown in FIG. 9 (S1). Note that any given mechanism can be used to detect the situation that the finger 57 is put on the surface area R10.

Next, as the biometric authentication is activated, the biometric authentication device embedded in the mobile phone 50 outputs test light in the forward direction (S2). That is, in the biometric authentication device, the arithmetic processing unit 7 calls up an image pickup control signal stored in the storage unit 8. Then, the biometric authentication device outputs that image pickup control signal to the control circuit that controls the light sources 200. The control circuit to which the image pickup control signal was input controls the light emission timing and the amount of light and the like of the light sources 200 based on that image pickup control signal. The light sources 200 emit test light to the finger 57 put on the surface area R10 of the mobile phone 50.

Next, the biometric authentication device obtains a vein pattern as an externally-incoming image (S3). Specifically, the image pickup device 100 selects the unit electrodes 15a to 15e one after another with the lapse of time while continuously selecting all the unit electrodes 14a to 14e, so that the unit areas R1 to R5 are successively established as a light transmission area.

That is, the image pickup device 100 selects the unit area 15a while continuously selecting all the unit electrodes 14a to 14e, and thereby applies a voltage to the unit area R1 of the liquid crystal panel 3, so that the unit area R1 becomes a light transmission area while the other unit areas R2 to R5 are remains as non-transmission areas. Note that the liquid crystal panel 3 in accordance with this exemplary embodiment of the present invention adopts the normally-black mode. However, the liquid crystal panel 3 may adopt the normally-white mode in other embodiments.

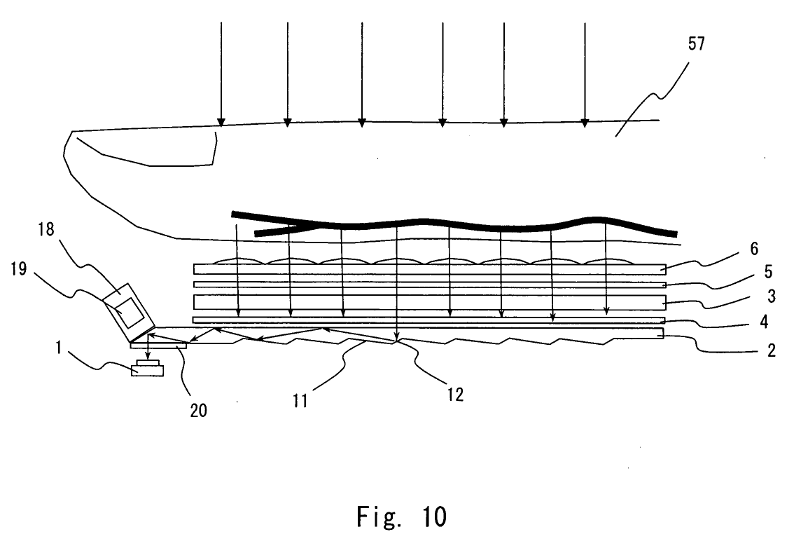

The finger 57 put on the surface area R10 of the mobile phone 50 is irradiated with test light from the light sources 200. The finger 57 has veins inside it, and the test light is absorbed by these veins. Biological tissues other than the veins hardly absorb test light. Transmitted light and reflected light from the finger 57 enter from the unit area R1 of the liquid crystal panel 3 as externally-incoming light, propagate through the guide members 2a to 3e, and are received by each of the pixels PXa to PXe of the line sensor 1. That is, as shown in FIG. 10, the externally-incoming light received in the unit area R1 of the liquid crystal panel 3 successively passes through the micro-lens array 6, the polarizing plate 5, the liquid crystal panel 3, and polarizing plate 4. The externally-incoming light that passed through the polarizing plate 4 enters the guide members 2a to 2e through the top surface of the guide members 2a to 2e. The image pickup device is configured such that the externally-incoming light received in the guide members 2a to 2e travels toward the left end of the guide members 2a to 2e by the reflection planes 12 provided on the bottom surface of the guide members 2a to 2e. That is, the externally-incoming light reflected on the reflection planes 12 of the guide members 2a to 2e travels toward the left end of the guide members 2a to 2e while repeatedly reflected on the interface between the guide members 2a to 2e and the polarizing plate 4 and on the reflection planes 11 and 12.

As described above, the reflection planes 13 are provided at the left ends of the guide members 2a to 2e. Therefore, externally-incoming light propagated through the guide members 2a to 2e is reflected on the reflection planes 13 and received by the pixels PXa to PXe of the line sensor 1 disposed below the reflection planes 13. After a certain amount of detection time (or accumulation time) is secured, the arithmetic processing unit 7 outputs a read signal (output instruction signal) to the line sensor 1. The pixels PXa to PXe output image signals indicating electrical charges accumulated in the respective pixels PXa to PXe to an analog/digital converter 30 based on the read signal. The analog/digital converter 30 converts the image signals to digital signals and outputs them to the arithmetic processing unit 7. The arithmetic processing unit 7 carries out image processing such as illumination distribution correction and noise reduction and the like on the image signals as required, and then carries out binarization processing and stores the processed image signals in the storage unit 8. Alternatively, the arithmetic processing unit 7 may store an original image in the storage unit 8 at first, and then carry out the above-mentioned image processing. The binarized image becomes an image reflecting the vein pattern in which areas corresponding to veins become black.

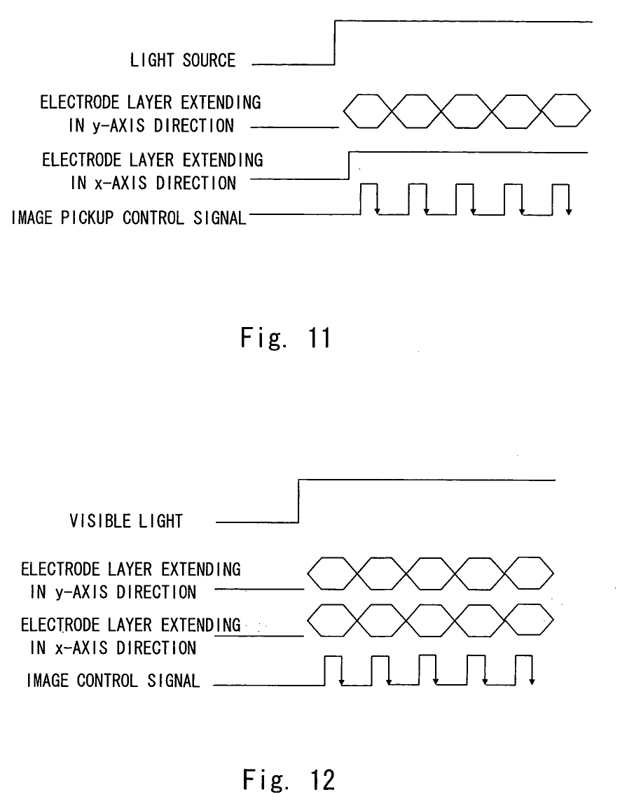

As described above, while the image pickup device 100 intermittently selects the unit electrodes 14a to 14e, the image pickup device 100 also selects the unit electrodes 15b, 15c, 15d, and 15e one by one so that the unit areas R2, R3, R4, and R5 are successively established as a light transmission area, and an image of the finger 57 is taken in each of the unit areas and the image signals are stored in the storage unit 8. The storage unit 8 generates an image of the vein pattern in the whole finger 57 as an externally-incoming image by combining image signals of the finger 57 taken in the respective unit areas. FIG. 11 shows each control signal of the light sources 200 and the liquid crystal panel 3 in this operation. Note that an image pickup control signal shown in FIG. 11 indicates the scanning timing of the liquid crystal panel 3.

Next, the arithmetic processing unit 7 determines whether the obtained vein pattern (obtained pattern) matches with a vein pattern (master pattern) that is registered in advance in the storage unit 8. This decision is carried out by the arithmetic processing unit 7 in accordance with a predefined algorism.

When the decision turned out to be a success, the mobile phone 50 activates the normal function of the mobile phone 50 (S5). For example, the mobile phone 50 cancels the lock mode. When the decision is turned out to be a failure, the mobile phone 50 maintains the non-operating state.

As can be seen from the above explanation, in the image pickup device 100 in accordance with this exemplary embodiment of the present invention, externally-incoming light that passed through the unit area established as a light transmission area enters each pixel of the line sensor 1 through the first light guide means 2. The image pickup device 100 successively shifts the unit area to be established as the light transmission area, and thereby successively detects an externally-incoming image in each unit area by the line sensor 1. In this way, the image pickup device 100 can take the whole externally-incoming image received in the surface area of the liquid crystal panel 3. Therefore, the image pickup device 100 makes it possible to take a desired image by using an image pickup element having a small number of pixels.

Further, the image pickup device 100 in accordance with this exemplary embodiment of the present invention, in which the unit electrodes are arranged so as to correspond to the respective unit areas, controls the range of voltage application to the liquid crystal layer by using these unit electrodes. In this way, the image pickup device 100 can establish the unit area to be established as a light transmission area in an intended range.

Further, the image pickup device 100 in accordance with this exemplary embodiment of the present invention can establish the unit area as a light transparent area or a light non-transparent area by using existing liquid crystal technology.

Further, the image pickup device 100 in accordance with this exemplary embodiment of the present invention guides externally-incoming light that passed through the unit area to the pixels of the line sensor 1 by using the plurality of guide members 2a to 2e. The image pickup device 100 can suppress crosstalk of light between each area more effectively by adopting a plurality of individually-divided guide members compared to cases where the guide members are constructed as one integral piece. Further, the image pickup device 100 uses plate-shaped optical members. Therefore, the thickness of the image pickup device 100 can be made satisfactory thinner. Further, a plurality of reflection planes are provided on the bottom surface of the guide members. Therefore, the image pickup device 100 can guide light to the line sensor 1 with efficiency.

Further, in the image pickup device 100, some of components are shared by neighboring liquid crystal display devices. In this way, it is possible for the mobile phone 50 to reduce the costs required to incorporate the image pickup device 100 into the mobile phone 50.

This image pickup device 100 is constructed in such a manner that a predefined unit area is established as a light transmission area based on electrical control and an image can be displayed by externally outputting light through the established unit area. That is, the image pickup device 100 is also equipped with a display function of displaying an image in predefined pixels of the liquid crystal panel 3.

Specifically, as shown in FIG. 4, the image pickup device 100 includes, in addition to the above-described structure, second light guide means 18, a visible-light source 19, and a visible-light cut filter 20.

The second light guide means 18 is an optical member that is provided to connect the reflection planes 13 of the guide members 2a to 2e of the first light guide means 2 with one another. The visible-light source 19 is provided in an end portion of the second light guide means 18.

The visible-light source 19 outputs visible-light having a wavelength band around 400 nm to 800 nm. The visible-light source 19 is composed of, for example, semiconductor LEDs (Light Emitting Diodes) or semiconductor LDs (Laser Diodes) This visible-light source 19 is controlled by a drive circuit (not shown).

The visible-light cut filter 20 is disposed so as to cover the line sensor 1. The visible-light cut filter 20 blocks visible-light to the line sensor 1. That is, the visible-light cut filter 20 is a plate-shaped (or film-shaped) optical member that blocks any disturbance light other than the test light. By covering the line sensor 1 with the visible-light cut filter 20, it is possible to prevent an electrical charge from being accidentally accumulated in pixels of the line sensor 1 by unnecessary externally-incoming light.

In the image pickup device 100 like this, an image control signal to be displayed in the surface area of the liquid crystal panel 3 is input, for example, from a processing circuit of the mobile phone 50 to the liquid crystal drive circuit 9. At the same time, that image control signal is also input to the drive circuit that controls the visible-light source 19.

The liquid crystal drive circuit 9 controls the unit electrodes 14a to 14e and 15a to 15e based on that image control signal so that predefined pixels of the liquid crystal panel 3 become a light transmission area and the other pixels become a non-transmission area. That is, when an image is displayed, each pixel of the liquid crystal panel 3 is defined as one unit area.

The drive circuit that controls the visible-light source 19 controls the visible-light source 19 based on that image control signal. The visible-light source 19 outputs visible-light to the second light guide means 18. FIG. 12 shows each control signal of the visible-light source 19 and the liquid crystal panel 3 in this operation. Note that the image control signal in FIG. 12 indicates the scanning timing of the liquid crystal panel 3.

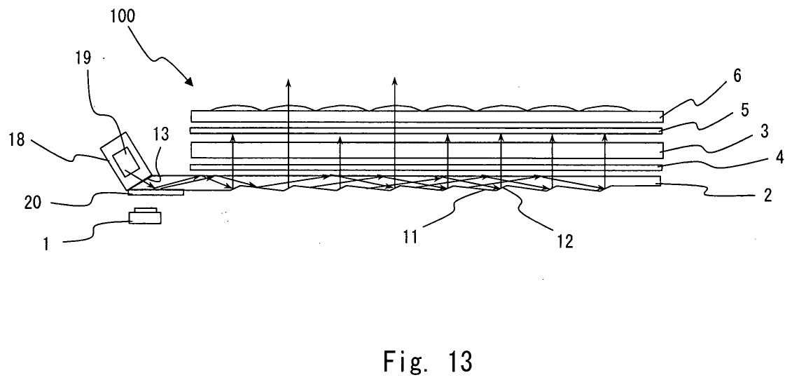

As shown in FIG. 13, this image pickup device 100 guides visible-light from the visible-light source 19 to the second light guide means 18. The visible-light enters from the reflection planes 13 of the guide members 2a to 2e. Further, the visible-light travels toward the right end of the guide members 2a to 2e by the reflection planes 11 provided on the bottom surface of the guide members 2a to 2e. That is, light reflected on the reflection planes 11 of the guide members 2a to 2e is output upward toward the liquid crystal panel 3 by the reflection planes 12 while repeatedly reflected on the interface between the guide members 2a to 2e and the polarizing plate 4 and on the reflection planes 11 and thus traveling toward the right end of the guide members 2a to 2e. Then, the visible-light passes through the predefined pixels of the liquid crystal panel 3 that are established as a light transmission area based on the image control signal. That is, the visible-light is externally output through the liquid crystal panel 3 and visually recognized as an image by the user. Examples of images displayed in the liquid crystal panel 3 include text information or symbols indicating that the obtained vein pattern matches with a vein pattern that is registered in advance in the storage unit 8 or other information.

As described above, the image pickup device 100 is constructed so as to include not only the image pickup function but also a display function. Therefore, it is possible to omit the liquid crystal display device embedded below the surface area R20 of the mobile phone 50. Consequently, it contributes to the space saving and the reduction in costs.

Further, the image pickup device 100 in accordance with this exemplary embodiment of the present invention can reduce the thickness of the mobile phone 50 because the first light guide means 2 is used for both occasions when an externally-incoming image is taken and when an image is displayed.

Furthermore, since the micro-lens array 6 is disposed in a layer above the liquid crystal layer 16 in the image pickup device 100 in accordance with this exemplary embodiment, dark spots between adjacent pixels of the liquid crystal layer 16 can be reduced.

### Second Exemplary Embodiment

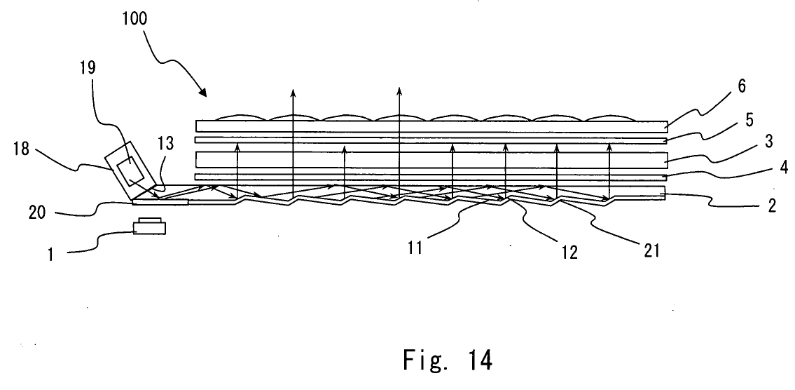

Note that as shown in FIG. 14, a metal reflection film 21 is preferably formed on the reflection planes 11 and 12 of each of the guide members 2a to 2e in the image pickup device 100 in accordance with the above-described first exemplary embodiment of the present invention. In this way, test light and visible-light that entered the guide members 2a to 2e do not leak from the bottom surface of the guide members 2a to 2e. Therefore, test light from the light sources 200 and visible-light from the visible-light source 19 can be used without waste, and thus increasing the light utilization efficiency.

### Third Exemplary Embodiment

Further, in the image pickup device 100 in accordance with the above-described first exemplary embodiment of the present invention, the second light guide means 18 is provided so as to connect the reflection planes 13 of the guide members 2a to 3e, and the visible-light source 19 is provided in an end portion of the second light guide means 18. However, the present invention is not limited to this configuration.

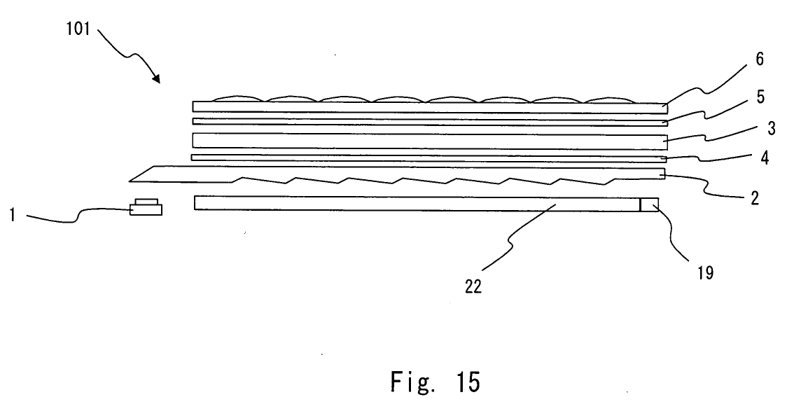

That is, as shown in FIG. 15, visible-light guide means 22 is disposed below the guide members 2a to 2e in an image pickup device 101 in accordance with a third exemplary embodiment of the present invention. A plurality of visible-light sources 19 are provided in one end portion of this visible-light guide means 22.

Though it is not shown in the drawings, the visible-light guide means 22 has a flat top surface and reflection planes are formed on its bottom surface in roughly the same manner as the first light guide means 2. Since the reflection planes are formed on the bottom surface of the visible-light guide means 22, visible-light received from the visible-light source 19 is output upward while traveling toward the other end portion of the visible-light guide means 22. The output visible-light passes through the first light guide means 2 and further passes through pixels, i.e., unit areas of the liquid crystal panel 3 that are established as a light transmission area, and then is visually recognized as an image by the user. In the image pickup device 101 like this, the visible-light cut filter 20 can be omitted.

However, the second light guide means 18 may be provided in one end portion of the visible-light guide means 22, and the visible-light source 19 may be provided in an end portion of this second light guide means 18.

### Fourth Exemplary Embodiment

Further, although the micro-lens array 6 is disposed in the uppermost layer in the above-described first exemplary embodiment of the present invention, it may be omitted.

The technical scope of the present invention is not limited to the above-described exemplary embodiments, and other various embodiments are conceivable. The setting values for the number and range of unit areas can be arbitrarily determined. The image pickup device itself is applicable to other various purposes in addition to biometric authentication devices. Further, the external devices to which the image pickup device is installed are not limited to mobile devices such as mobile communication terminals. The objects to be observed for biometric authentication are not limited to human fingers, and other ports of body including human palms may be used.

Unit electrodes to be selected may be established as appropriate according to the liquid crystal display mode such as a normally-black mode and a normally-white mode. Note that a unit area may be established as a light transmission area or non-transmission area by using electrooptic crystals whose transparency is changed according to an applied voltage, instead of using the liquid crystal technology.

The image pickup elements are not limited to guide members and the likes, and any element capable of guiding light from a unit area established as a light transmission area to pixels of the image pickup element can be used for that purpose. The guide members 2a to 2e are not limited to the one composed of individual elements, and may be an element in which they are formed as one integral piece. Further, pixels of the line sensor 1 and the guide members do not necessarily have to be provided on a one-to-one basis. One guide member may be assigned to a plurality of pixels. Specific material for each component can be selected as appropriate by those skilled in the art.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An image pickup device having a display function, in which an image receiving surface is divided into a plurality of unit areas, configured to:
establish a predefined unit area as a light transmission area based on electrical control, receive externally-incoming light through this established unit area, and take an externally-incoming image based on that externally-incoming light; and
establish a predefined unit area as a light transmission area based on electrical control, and display an image by externally outputting light through this established unit area.

2. The image pickup device having a display function according to claim 1, comprising:
a filter layer in which the image receiving surface is divided into the plurality of unit areas and a predefined unit area is established as a light transmission area based on electrical control;
an image pickup element comprising at least one pixel row;
first light guide means that guides externally-incoming light from the filter layer to the pixel row; and
a visible-light source that generates light to be externally output through the filter layer.

3. The image pickup device having a display function according to claim 2, wherein the first light guide means is an optical member that guides received externally-incoming light to pixels of the image pickup element through a plurality of reflection planes.

4. The image pickup device having a display function according to claim 3, wherein the optical member is composed of a plurality of guide members arranged adjacent to one another.

5. The image pickup device having a display function according to claim 4, wherein each of the plurality of the guide members comprises:
a plurality of first reflection planes that direct received externally-incoming light toward one end of that guide member; and
a second reflection plane provided on the one end side of that guide member, the second reflection plane being configured to reflect externally-incoming light that propagated through that guide member toward pixels of the image pickup element.

6. The image pickup device having a display function according to claim 5, wherein
the image pickup device comprises second light guide means disposed so as to connect the second reflection planes of the plurality of guide members with one another, and the visible-light source is disposed in an end portion of the second light guide means; and
the first reflection planes of the guide members reflect light received from the visible-light source toward the filter layer while making the received light propagate toward the other end of the guide members.

7. The image pickup device having a display function according to claim 2, wherein
the filter layer is a dot-matrix type liquid crystal panel, and comprises:
a liquid crystal layer;
electrode layers that sandwich the liquid crystal layer, the electrode layers being capable of applying a voltage to each pixel of the liquid crystal layer; and
a liquid crystal drive circuit that controls the electrode layers such that a predefined unit area in the liquid crystal layer becomes a light transmission area.

8. The image pickup device having a display function according to claim 6, wherein
the filter layer is a dot-matrix type liquid crystal panel, and comprises:
a liquid crystal layer;
electrode layers that sandwiches the liquid crystal layer, the electrode layers being capable of applying a voltage to each pixel of the liquid crystal layer; and
a liquid crystal drive circuit that controls the electrode layers such that a predefined unit area in the liquid crystal layer becomes a light transmission area.

9. The image pickup device having a display function according to claim 7, wherein each of a plurality of unit areas is made a light transmission area or a light non-transmission area, and thereby creating a state where externally-incoming light enters the light transmission area, the plurality of unit areas being defined by dividing the image receiving surface of the filter layer by a plurality of first axes.

10. The image pickup device having a display function according to claim 8, wherein each of a plurality of unit areas is made a light transmission area or a light non-transmission area, and thereby creating a state where externally-incoming light enters the light transmission area, the plurality of unit areas being defined by dividing the image receiving surface of the filter layer by a plurality of first axes.

11. The image pickup device having a display function according to claim 4, wherein
the plurality of pixels of the image pickup device are arranged along the first axes, and
each of the plurality of guide members extends along second axes perpendicular to the first axes.

12. The image pickup device having a display function according to claim 4, wherein
the plurality of guide members is disposed above the image pickup element, and
the filter layer is disposed above the plurality of guide members.

13. The image pickup device having a display function according to claim 5, wherein a metal reflection film is formed on the first reflection planes of the guide members.

14. The image pickup device having a display function according to claim 2, wherein
the visible-light source is disposed in an end portion of the visible-light guide means disposed below the plurality of the guide members, and
the visible-light guide means outputs received light to the filter layer through the plurality of guide members.

15. The image pickup device having a display function according to claim 2, further comprising a visible-light cut filter that blocks visible-light to the image pickup element.

16. The image pickup device having a display function according to claim 2, wherein an object to be tested is irradiated with externally-incoming light and a vein image is taken as an externally-incoming image, the object to be tested being placed on the image receiving surface of the filter layer, and the externally-incoming light being near-infrared light.

17. A mobile communication terminal comprising an image pickup device according to claim 1.
